(19) United States
(12) Patent Application Publication
(10) Pub. No.: US 2015/0269925 A1
(43) Pub. Date: Sep. 24, 2015

(54) VEHICLE APPROACH NOTIFICATION APPARATUS

(71) Applicant: FUJI JUKOGYO KABUSHIKI KAISHA, Tokyo (JP)

(72) Inventor: Hiroaki KANAYA, Tokyo (JP)

(73) Assignee: FUJI JUKOGYO KABUSHIKI KAISHA

(21) Appl. No.: 14/659,168

(22) Filed: Mar. 16, 2015

(30) Foreign Application Priority Data
Mar. 19, 2014 (JP) 2014-056582

(51) Int. Cl. G10K 11/178; B60Q 5/00

(52) U.S. Cl. CPC G10K 11/178; B60Q 5/008; G10K 2210/1282

(57) ABSTRACT

A vehicle approach notification apparatus includes: a notification sound signal generator that generates and outputs a notification sound signal that serves as a sound signal to be supplied to an external speaker that outputs a notification sound toward an outside of a vehicle; and a cancellation signal generator that generates a cancellation signal that serves as a sound signal to be supplied to a compartment speaker to output a sound and that has an antiphase with respect to a phase of the notification sound signal output from the notification sound signal generator.

### CROSS-REFERENCE TO RELATED APPLICATIONS

The present application claims priority from Japanese Patent Application No. 2014-056582 filed on Mar. 19, 2014, the entire contents of which are hereby incorporated by reference.

### BACKGROUND

1. Technical Field

The present invention relates to a vehicle approach notification apparatus that is installed in an electric vehicle, a hybrid vehicle, and the like and outputs a sound for notifying the approach of the vehicle.

2. Related Art

A system that serves as a so-called active noise canceller for a vehicle is known. The system is provided with a microphone disposed in a compartment, uses a sound (noise) collected by the microphone to generate a signal having an antiphase to the sound, and outputs the signal from a compartment speaker, thereby canceling noise.

Japanese Unexamined Patent Application Publication (JP-A) No. 2007-171657 and JP-A No. 2001-290489 each disclose a technique that reduces noise that is caused by engine sound and enters a compartment. Specifically, the technique outputs in the compartment a canceling sound having an antiphase and an equal sound pressure with respect to engine noise.

Usually, a gasoline-powered vehicle emits a large engine sound and a large exhaust gas sound. A pedestrian or the like can recognize the approach of a vehicle by these sounds. However, an electric vehicle or a hybrid vehicle can be travel with an electric motor and an engine can be stopped while traveling. In such a case, a sound generated by the vehicle while traveling is very silent. Consequently, it is difficult for pedestrians or the like to detect the approach of the vehicle. Thus, in order to cause a person near the vehicle to detect the approach of the vehicle by sense of hearing, a vehicle approach notification apparatus is provided in the vehicle so that a pseudo vehicle traveling sound is output toward a vehicle exterior.

The vehicle approach notification apparatus generates a sound signal that serves as a vehicle approach notification sound and outputs the signal from a speaker towards outside the vehicle. Thus, the sound signal causes, for example, a person (pedestrian, person on a bicycle, or the like) who is in an area in a vehicle traveling direction to be aware of the approach of the vehicle. The notification sound output from the speaker also enters the compartment. This will be bothersome to occupants of the vehicle. In particular, when the vehicle is traveling at a low speed (for example, 0 to 30 km/h), the occupants always hear the notification sound and will feel bothered.

### SUMMARY OF THE INVENTION

The present invention has been designed in consideration of the circumstances described above, and an object thereof is to provide a vehicle approach notification apparatus that reducing the volume of the notification sound, thereby reducing the unpleasantness felt by the occupants and further enhancing safety.

An first aspect of the present invention provides a vehicle approach notification apparatus for a vehicle including: a notification sound signal generator that generates and outputs a notification sound signal that serves as a sound signal to be supplied to an external speaker that outputs a notification sound toward an outside of a vehicle; and a cancellation signal generator that generates a cancellation signal that serves as a sound signal to be supplied to a compartment speaker to output a sound and that has an antiphase with respect to a phase of the notification sound signal output from the notification sound signal generator.

The vehicle approach notification apparatus may further include a control unit that controls the notification sound signal generator and the cancellation signal generator. The control unit controls the cancellation signal generator such that an output level of the cancellation signal is lowered in the case where a person is detected based on an information on person detection supplied from a forward monitoring apparatus.

The control unit may control, when a person is detected, the cancellation signal generator such that the output level of the cancellation signal is lowered in response to an information supplied from the forward monitoring apparatus, which indicates a distance from the vehicle to the person.

The control unit may control the cancellation signal generator such that the cancellation signal is supplied to the compartment speaker to achieve a state in which cancellation of the notification sound is optimized in a compartment under a condition that the control unit detects that the vehicle slowly travels with a motor at a speed equal to or lower than a predetermined speed and no person is detected through the person detection.

The control unit may receive from an operation unit information indicating that an occupant in the vehicle performs an operation to turn off the notification sound. The control unit may stop outputting the notification sound signal from the notification sound signal generator under a condition that the control unit detects information indicating that the operation is performed to turn off the notification sound. The control unit may starts outputting the notification sound signal from the notification sound signal generator and control the cancellation signal generator to lower an output level of the cancellation signal in the case where a person is detected based on the information on person detection supplied from the forward monitoring apparatus.

### BRIEF DESCRIPTION OF THE DRAWINGS

FIG. 1 is an explanatory view of a vehicle system equipped with a vehicle approach notification apparatus according to an implementation of the invention;

FIG. 2 is a block diagram of the vehicle approach notification apparatus and its peripheral devices according to the implementation;

FIGS. 3A, 3B, 3C, and 3D are explanatory views that illustrates the recognition of a pedestrian and the like according to implementation; and

FIG. 4 is a flowchart that illustrates a routine in operation of the vehicle approach notification apparatus according to the implementation.

### DETAILED DESCRIPTION

Hereinafter, a preferred implementation of the present disclosure will be described in detail with reference to the accompanying drawings. A vehicle approach notification apparatus according to the implementation is to be installed in an electric vehicle or a hybrid vehicle

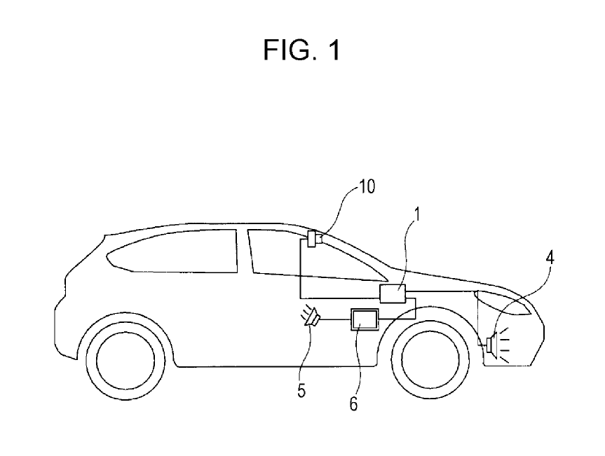

FIG. 1 illustrates a schematic view of a system inside a vehicle. As illustrated in FIG. 1, a vehicle approach notification apparatus 1 according to the implementation uses an external speaker 4, a compartment speaker 5, an audio unit 6, and a forward monitoring apparatus 10.

The vehicle approach notification apparatus 1 sends a sound signal that serves as a notification sound for notifying the approach of the vehicle (hereinafter also referred to “an notification sound”) to the external speaker 4 to output a sound to an area around a vehicle equipped with the vehicle approach notification apparatus 1.

The forward monitoring apparatus 10 captures an image of a front view with a stereo camera assembly and analyzes a captured image to output information regarding the situation in front of the vehicle. The forward monitoring apparatus 10 can obtain information on detection of an object such as a preceding vehicle, a pedestrian, an obstacle, and a lane in front the vehicle, and information on distance from the vehicle to the detected object. Such information is processed by an electronic control unit (ECU; not shown) or the like to be used for automatic stop control, automatic cruise control and the like for avoidance of a collision. For the implementation, such information is supplied to the vehicle approach notification apparatus 1.

The audio unit 6 is a general car stereo unit. The audio unit 6 has a sound-reproducing device such as a compact disc (CD) player, a radio tuner, a cassette deck, and a hard disk drive (HDD) music player, and an amplifier that amplifies a reproduced sound signal. A sound signal output from the audio unit 6 is supplied to the compartment speaker 5 to output a sound. As a result, an occupant of the vehicle including a driver can listen to music, a radio broadcast, or the like.

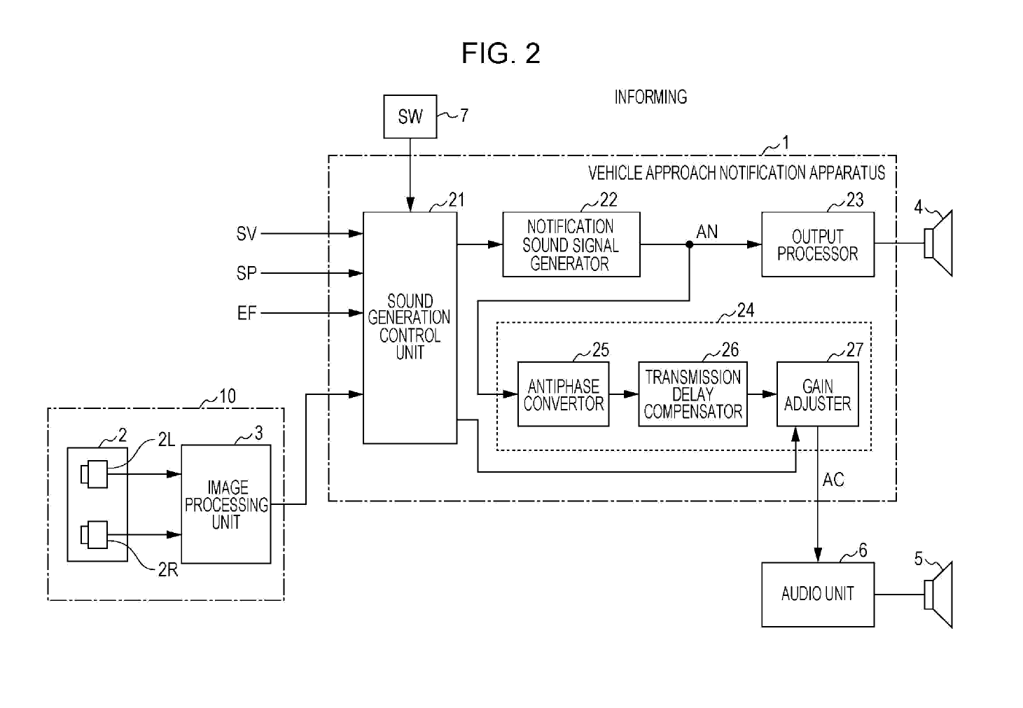

FIG. 2 is a block diagram illustrating an example of a configuration of the vehicle approach notification apparatus 1 and an example of a connection between the apparatus 1 and its peripheral devices. The vehicle approach notification apparatus 1 includes a sound generation control unit 21, a notification sound signal generator 22, an output processor 23, and a cancellation signal generator 24.

The notification sound signal generator 22 is configured to, for example, store sound source data for the notification sound in an internal memory and repeatedly read out the sound source data to output an notification sound signal AN in the form of a digital sound signal.

The notification sound signal AN is converted into an analog sound signal by digital-analog (D/A) conversion in the output processor 23. Then, the analog sound signal is processed through impedance matching, power amplification and the like and supplied to the external speaker 4, to be output outward from the vehicle.

The cancellation signal generator 24 includes an antiphase converter 25, a transmission delay compensator 26, and a gain adjuster 27.

The notification sound signal AN output from the notification sound signal generator 22 is supplied also to the antiphase converter 25 to be converted into an antiphase sound signal (a cancellation signal AC). The antiphase sound signal is subjected to delay processing by the transmission delay compensator 26 in accordance with transmission delay of the notification sound. Specifically, since it takes a time, or transmission delay time, for the notification sound output from the external speaker 4 to reach a compartment through the vehicle body, the same delay as that of the notification sound in the compartment is applied to the cancellation signal AC. An output level of the delayed cancellation signal AC is adjusted by gain adjustment in the gain adjuster 27, and then the delayed cancellation signal AC is output to the audio unit 6.

The cancellation signal AC may be transmitted to the audio unit 6 in the form of a digital sound signal and may be converted into an analog signal in the audio unit 6. Alternatively, the cancellation signal AC may be converted into an analog signal by the D/A conversion in the gain adjuster 27 and may be transmitted to the audio unit 6 in the form of the analog sound signal.

The audio unit 6 applies a necessary process such as a mixing process, a power amplifying process, an impedance matching process, or the like to the supplied cancellation signal AC and sends the processed cancellation signal AC to the compartment speaker 5 to output the cancellation signal AC in the form of a canceling sound to the compartment. For example, if the audio unit 6 performs a reproduced-sound outputting process of a CD or the like, a reproduced-sound output signal is mixed with the cancellation signal AC and the mixed-sound signal is supplied to the compartment speaker 5. If the reproduced-sound outputting process is not performed, the audio unit 6 supplies only the cancellation signal AC to the compartment speaker 5 to cause the speaker 5 to output the cancellation signal AC only.

A sound volume adjustment and a sound tone adjustment concerning a reproduced music or the like are performed in the audio unit 6 in accordance with an operation of the occupant. However, the present implementation avoids the sound volume adjustment and the sound tone adjustment from being applied to the canceling sound of the cancellation signal AC. Accordingly, it is suitable to mix the cancellation signal AC after completing the sound volume adjustment and the sound quality adjustment of the reproduced music or the like.

Since a component of the canceling sound according to the cancellation signal AC is output from the compartment speaker 5, an acoustic wave having an antiphase with respect to a phase of an acoustic wave of the notification sound to be transmitted to the compartment is generated. As a result, the notification sound is cancelled. That is, the noisy notification sound for the occupant in the compartment is cancelled, and a quiet environment can be provided to the occupant in the compartment of the vehicle.

The sound generation control unit 21 includes, for example, a microcomputer, and controls the notification sound signal generator 22 and the cancellation signal generator 24. Specifically, the sound generation control unit 21 perform start/stop control of the notification sound signal AN to the notification sound signal generator 22. Also, the sound generation control unit 21 particularly provides an instruction to the gain adjuster 27 of the cancellation signal generator 24 to control an output level of the cancellation signal AC.

In the present implementation, a notification sound off-switch 7 is provided. The occupant can operate the notification sound off-switch 7 to select an on-state or an off-state. When the occupant considers that the output of the notification sound is unnecessary, the occupant operates the notification sound off-switch 7. That is, when the notification sound off-switch 7 is turned on, the vehicle approach notification apparatus 1 stops outputting the notification sound from the external speaker 4.

Accordingly, operational information from the notification sound off-switch 7 is supplied to the sound generation control unit 21. In the case where the sound generation control unit 21 detects that the notification sound off-switch 7 is turned on, the sound generation control unit 21 controls the notification sound signal generator 22 to stop outputting the notification sound signal AN.

The sound generation control unit 21 receives information from various sensors, the ECU, and the like installed in the vehicle. FIG. 2 illustrates that the sound generation control unit 21 receives vehicle speed information SV, shift position information SP, and a motor traveling flag EF to.

The vehicle speed information SV is traveling speed information of the vehicle and is supplied from a vehicle speed sensor installed in the vehicle directly to or indirectly via the ECU or the like to the sound generation control unit 21.

The shift position information SP indicates a shift position and is supplied from a shift position sensor installed in the vehicle directly to or indirectly via the ECU or the like to the sound generation control unit 21.

The motor traveling flag EF indicates whether a vehicle is traveling with an engine or a motor, in particularly in the case where the vehicle is a hybrid vehicle. For example, the flag EF is supplied from, for example, the ECU to the sound generation control unit 21.

The sound generation control unit 21 controls the notification sound signal generator 22 and the cancellation signal generator 24 in accordance with the above kinds of information.

The sound generation control unit 21 also receives from the forward monitoring apparatus 10 information on, for example, detection of a person and distance from the vehicle to the person. The sound generation control unit 21 controls the notification sound signal generator 22 and the cancellation signal generator 24 also in accordance with information from the forward monitoring apparatus 10.

In the exemplary configuration illustrated in FIG. 2, the cancellation signal generator 24 can be realized by a digital signal processor (DSP). Specifically, digital filtering or the like of the DSP can realize antiphase conversion, transmission delay compensation, and gain adjustment.

The notification sound signal generator 22 and the output processor 23 can be also contained in the DSP. Furthermore, it is possible to form the entire vehicle approach notification apparatus 1 including the sound generation control unit 21.

The forward monitoring apparatus 10 includes an imaging unit 2 and an image-processing unit 3. The imaging unit 2 serves as the stereo camera assembly having a right camera 2R and a left camera 2L. The cameras 2R and 2L are separated apart from each other in a width (horizontal) direction of the vehicle. The image-processing unit 3 analyzes captured image signals from the right and left cameras 2R and 2L.

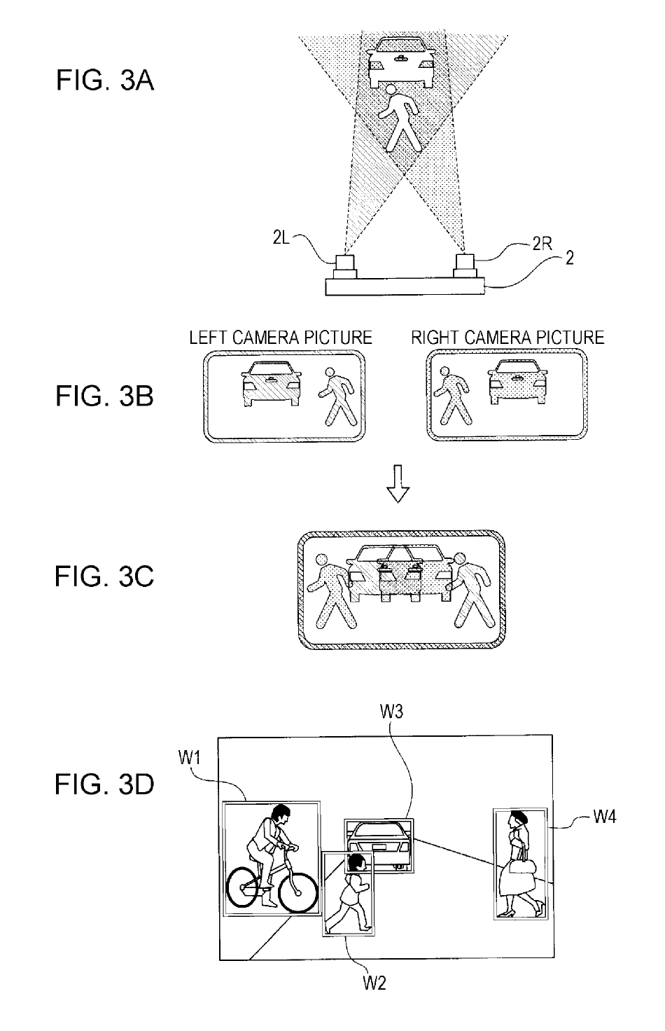

Person detection performed by the forward monitoring apparatus 10 will be described below by referring to FIGS. 3A to 3D.

Recognition of an object such a lane line and an obstacle in front of the vehicle through the use of the stereo camera assembly is carried out on the basis of a principle of a triangulation method. Image information obtained by two cameras (the right and left cameras 2R and 2L) is converted into three-dimensional information to determine the distance and size of the detected object on the basis of the triangulation principle.

FIG. 3A schematically illustrates a case of imaging sight views of the right and left cameras 2R and 2L in the imaging unit 2. Since the right and left cameras 2R and 2L are separated apart from each other in the width (horizontal) direction, each of the right and left cameras 2R and 2L has the corresponding imaging sight view illustrated by a broken line in FIG. 3A. If there is a person or a vehicle in front of the vehicle, the right and left cameras 2R and 2L capture respective images illustrated in FIG. 3B.

In FIG. 3C, the two images are overlapped. Positions of a same object (a person in the figure) near the vehicle of the implementation are shifted by a large amount while positions of a same object (a preceding vehicle) distant from the vehicle are shifted by a small amount. It is possible to measure a distance from the vehicle to an object by utilizing this principle.

The image-processing unit 3 can identify a three-dimensional object such as a vehicle, a two-wheel vehicle, a pedestrian, and a guardrail, and a lane line (such as a white line) on the basis of the size, outline, pattern (a design) from the obtained image data. It is possible to identify a pedestrian by extracting an outline of the pedestrian from image data and then comparing the extracted outline with a model pattern for pedestrians. FIG. 3D illustrates a state in which persons and a preceding vehicle are recognizes as obstacles in front of the vehicle. Frames W1, W2, and W4 illustrate detection areas of persons (pedestrians, a person on a bicycle). The frame W3 illustrates a detection area of a preceding vehicle.

The image-processing unit 3 in the forward monitoring apparatus 10 detects an object in front of the vehicle with the above processing. In particular, in the implementation of the invention, the image-processing unit 3 supplies detection information regarding a person (pedestrian, person on a bicycle, or the like), distance information on the detected person, and lane line information to the sound generation control unit 21.

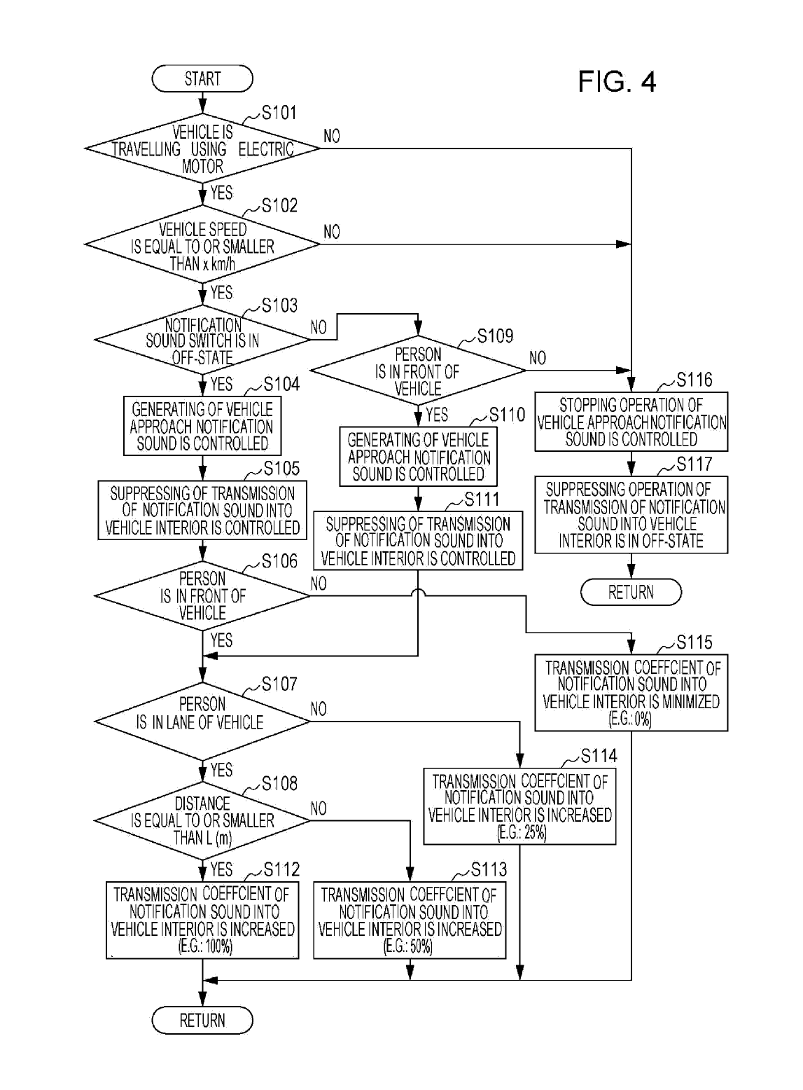

FIG. 4 illustrates an example of processing that the vehicle approach notification apparatus 1 performed with the above configuration. FIG. 4 illustrates processing in the sound generation control unit 21.

The sound generation control unit 21 determines in step S101 whether the vehicle is now traveling with an electric motor. For example, in the case of a hybrid vehicle, this process determines whether the vehicle is not in a stop state but in a traveling state and whether the vehicle is traveling not with an internal-combustion-engine using gasoline or the like but with an electric motor. In the case of the electric vehicle, since the vehicle is naturally traveling with the electric motor, it is determined only whether the vehicle is in a traveling state or in a stopped state. In step S101, the sound generation control unit 21 checks vehicle speed information SV, shift position information SP, and further a motor traveling flag EF (in the case of the hybrid vehicle).

In the case where the vehicle is not using the electric motor, the notification sound is not output. Specifically, the sound generation control unit 21 advances to step S116 to supply an output stop command to the notification sound signal generator 22 as stop control of the notification sound (when the notification sound has not been output already, this control is not necessary). That is, the notification sound from the external speaker 4 is stopped or an output stop state is maintained.

In step S117, an output of the cancellation signal AC is stopped in line with stoppage of the notification sound (when the output of the cancellation signal AC has been stopped already, this control is not necessary). That is, the canceling sound from the compartment speaker 5 is stopped, or the output stop state is maintained. Then, the sound generation control unit 21 returns to Start and repeats the processing from step S101.

In the case where it is determined in step S101 that the vehicle is traveling by the electric motor, the sound generation control unit 21 advances to step S102 to detect vehicle speed information SV and determine whether the vehicle is traveling at a low speed that is equal to or lower than x [km/h]. For example, in the case of x=30, it is determined in step S102 whether the vehicle speed is equal to or lower than 30 km/h.

If the vehicle speed exceeds x [km/h], the notification sound is not output. Consequently, the sound generation control unit 21 returns to Start from step S102 via steps S116 and S117.

If the vehicle speed is equal to or lower than x [km/h], the sound generation control unit 21 advances to step S103 to subsequently check the operation state of the notification sound off-switch 7. Since the occupant usually operates the notification sound off-switch 7 to stop the notification sound to be generated, the off-state in which the occupant does not operate the off-switch 7 is a normal state.

If the notification sound off-switch 7 is in the normal state where it is off, the sound generation control unit 21 advances to step S104 to control the notification sound. Specifically, if the notification sound has not been output until this time, the sound generation control unit 21 sends an output instruction command to the notification sound signal generator 22 to start outputting the notification sound signal AN. If the notification sound has already been output, the sound generation control unit 21 causes the notification sound signal generator 22 to keep outputting the notification sound signal AN. The sound generation control unit 21 does not, for example, renew the output instruction command, or generate the output stop command. Thus, the external speaker 4 starts or continues to output the notification sound.

In step S105, The sound generation control unit 21 instructs outputting of the cancellation signal AC together with outputting of the notification sound. That is, the output of the cancellation signal AC is started in line with outputting of the start of the notification sound. Specifically, the sound generation control unit 21 causes the gain adjuster 27 to start to supply the cancellation signal AC to the audio unit 6. If the notification sound has already been output before this time, the sound generation control unit 21 maintains outputting of the cancellation signal AC in step S105.

In step S106, the sound generation control unit 21 checks information obtained from the forward monitoring apparatus 10 to examine whether there is any person in front of the vehicle. If it is determined that there is no person in front of the vehicle, the sound generation control unit 21 advances to step S115 where a transmission coefficient of the notification sound transmitted into the vehicle compartment is controlled to be minimized (ideally, to 0%).

The transmission coefficient described here means the proportion of the notification sound leaking into the compartment from the external speaker 4. For ease explanation, the transmission coefficient of 100% is for the case when the notification sound that leaks into the compartment from the external speaker 4 and is heard by the occupant in the compartment under the condition that the canceling sound is not output. The transmission coefficient of 0% is for the case when the occupant in the compartment cannot hear the notification sound output from the external speaker 4 in the vehicle exterior.

Specifically, the sound generation control unit 21 uses the gain adjuster 27 to adjusts a gain value for the cancellation signal AC such that a canceling effect on the notification sound transmitted to the compartment is optimized. For example, the gain value is set so that a sound pressure level of the notification sound transmitted from the external speaker 4 into the compartment is equal to the sound pressure level of the canceling sound supplied to the compartment in response to the cancellation signal AC. This gain value may be set by a predetermined measurement so that the canceling effect of the notification sound is optimized.

The actual canceling effect of the notification sound is comprehensively influenced by phase conversion in the antiphase converter 25, the delay amount in the transmission delay compensator 26, and gain setting in the gain adjuster 27. In step S115, the canceling effect by the gain adjustment is optimized as an example.

The gain value that can optimize the canceling effect of the notification sound may be a value by which the maximum canceling effect of the notification sound can be achieved. Alternatively, the gain value may be a value by which the canceling effect can be achieved not to the maximum extent but to some extent (to an extent where the occupant finds it difficult to perceive the notification sound). That is, the word “optimization” does not always mean the maximum effect but means the highest effective condition in cancellation of the notification sound. Accordingly, the minimization of the transmission coefficient does not always mean the transmission coefficient of 0% and the meaning thereof includes a high canceling effect state (for example, 10% or so) in comparison with the states illustrated in steps S112, S113, and S114 described below.

In the case where a person is detected in step S106, the sound generation control unit 21 advances to step S107 to check information from the forward monitoring apparatus 10 to determine whether or not the detected person (pedestrian, person on a bicycle, or the like) is in a lane of the vehicle. For example, the lane line information and position information of the detected person are used to determine whether or not the person is in the lane of the vehicle. The detection of a person in the lane of the vehicle can be paraphrased as the detection of a person in front in the travelling direction of the vehicle. Thus, even on a road where lane lines are not marked, when the person is detected in front in the traveling direction, it may be determined that the person is in the lane of the vehicle.

If the detected person is not in the lane of the vehicle, the sound generation control unit 21 advances to step S114 to control the gain value of the gain adjuster 27 so that the notification sound is slightly transmitted into the compartment (for example, a transmission coefficient of 25%). That is, the canceling effect is slightly lowered so that the occupant can recognize the notification sound to some degree.

If it is determined that the detected person is in the lane of the vehicle, the sound generation control unit 21 advances to step S108 to determine whether the distance from the vehicle to the person in the lane is equal to or smaller than L (m; meters). For example, in the case of L=10, it is determined whether the distance is equal to or smaller than 10 m.

If the distance exceeds L (m), the sound generation control unit 21 advances to step S113 to control the gain value in the gain adjuster 27 so that the transmission coefficient of the notification sound transmitted to the compartment becomes an intermediate transmission coefficient (for example, a transmission coefficient of 50%). That is, the canceling effect is lowered to 50% so that the occupant can recognize the notification sound at a slightly larger volume.

In the case where it is determined in step S108 that the detected person is within a distance of, for example, 10 m in the lane of the vehicle and the vehicle is approaching the person, the sound generation control unit 21 advances to step S112 to increase the transmission coefficient of the notification sound into the compartment. For example, the transmission coefficient is set to be 100%, that is, the cancellation of the notification sound is not performed. Specifically, the gain is set to be zero (0) by the gain adjuster 27, or outputting of the cancellation signal AC from the gain adjuster 27 is stopped.

In spite of completely stopping the cancellation signal AC, the gain for the cancellation signal AC may significantly be lowered such that the transmission coefficient becomes 90% or so. In either case, step S112 is executed so that the occupant can sufficiently hear the notification sound.

After performing the gain control for the transmission coefficient of the notification sound in any one of steps S112, S113, S114, and S115, the sound generation control unit 21 returns to Start. Then, the sound generation control unit 21 repeats the processing from step S101.

As described above, the process in any one of steps S112, S113, S114, and S115 is selected on the basis of detection of a person (pedestrian, person on a bicycle, or the like), a position of the person (in or out the lane of the vehicle), and the distance from the vehicle to the person. As a result, the degree of the canceling effect of the notification sound in the compartment is variably set.

In the case where the notification sound off-switch 7 is turned to the on-state by the occupant, the following processing will be performed.

In the case when it is detected in step S103 that the notification sound off-switch 7 is turned on, the sound generation control unit 21 advances to step S109 to determine whether or not a person is in front of the vehicle on the basis of information from the forward monitoring apparatus 10. If it is determined that there is no person in front of the vehicle, the notification sound is not output in accordance with the intention by the occupant (the on-operation of the notification sound off-switch 7), even if the vehicle is traveling with the electric motor at a low speed of x [km/h]. Thus, the sound generation control unit 21 executes steps S116 and S117 to stop outputting of the notification sound (and the canceling sound), and returns to Start.

Even during a period in outputting of the notification sound is stopped with the notification sound off-switch 7, if a person is detected in front of the vehicle in step S109, the sound generation control unit 21 advances to step S110 to control generating of the notification sound. As is the case with step S104, the sound generation control unit 21 causes the notification sound signal generator 22 to start or continue outputting of notification sound signal AN. This causes the external speaker 4 to start or continue a state in which the notification sound is output.

Subsequently, in step S111, the sound generation control unit 21 starts or continues outputting of the cancellation signal AC in line with the output of the notification sound. Then, the sound generation control unit 21 branches to any one of steps S112, S113, and S114 based on the determination results of steps S107 and/or S108.

As described above, in the case where a person is detected in front of the vehicle, even if the notification sound off-switch 7 is turned on (a stop operation of the notification sound output), the notification sound is output and the canceling sound is output in the compartment in response to the notification sound. Furthermore, the canceling of the notification sound is set variable in accordance with the position of the detected person and the distance from the vehicle to the person.

The following effects are obtained in the above implementation of the invention.

The vehicle approach notification apparatus 1 of the implementation includes the notification sound signal generator 22 and the cancellation signal generator 24. The notification sound signal generator 22 generates and outputs the notification sound signal AN as the sound signal to be supplied to the external speaker 4 that outputs the notification sound toward the vehicle exterior. The cancellation signal generator 24 generates the cancellation signal AC having an antiphase with respect to the phase of the notification sound signal AN as the sound signal to be supplied to the compartment speaker 5 to output a sound.

The notification sound from the external speaker 4 may become noisy for the occupant and bother the occupant, whereby the riding environment may be deteriorated. In the implementation, the canceling sound is output on the basis of the cancellation signal AC having an antiphase with respect to the phase of the notification sound signal AN, thereby realizing a riding environment that removes the noise.

In particular, the implementation does not generate a cancellation signal having an antiphase with respect to the phase of a sound collected with a microphone, but generate the cancellation signal AC that has an antiphase with respect to a phase of the notification sound signal AN to be generated. Thus, a configuration for outputting the canceling sound can be simplified and a canceling effect that specifically cancels only the notification sound can be realized.

If a cancellation signal AC is generated that has an antiphase with respect to the phase of a sound collected by the microphone in the compartment, another sound other than the notification sound in the compartment may be subject to the canceling effect. For example, a sound such as music reproduced by an audio unit 6 may be subject to the canceling effect. In order to avoid this, a complicated process is required such as removing a signal of the reproduced sound from the cancellation signal. In the implementation, on the other hand, it is very easy to generate the cancellation signal AC based on the notification sound. Furthermore, the canceling effect affects only the notification sound entering the compartment, and does not affect the reproduced sound such as music. That is, it is possible to suitably cancel the noise with a simple system.

Also, it is preferable for the driver to hear a sound around the vehicle during traveling and to become easily aware of surrounding environment. The canceling sound of the implementation does not effect on sounds from the surrounding environment. Accordingly, the implementation is also preferable in view of improvement of safety.

Also, the vehicle approach notification apparatus 1 includes the sound generation control unit 21 that controls the notification sound signal generator 22 and the cancellation signal generator 24. The sound generation control unit 21 controls the cancellation signal generator 24 to lower the output level of the cancellation signal AC, in the case where the person is detected with information on detection of a person (pedestrian, person on a bicycle, or the like) from the forward monitoring apparatus 10. That is, when step S106 in FIG. 4 does not detect a person, step S115 minimizes the transmission coefficient of the notification sound entering the compartment. On the other hand, when step S106 detects a person, one of steps S112, S113, and S114 lowers the output level of the cancellation signal AC to lower the canceling effect.

Consequently, when a person is present near the vehicle, it is easy for the occupant to hear the notification sound. That is, if a person is detected in the vehicle traveling direction, the driver can hear the notification sound in the compartment and thus can be aware of the person near the vehicle. It is also possible to indicate to the driver the presence of a person due to a change in sound in the compartment, thereby obtaining an effect of calling the driver's attention to perform safe driving.

In the vehicle approach notification apparatus 1, in the case where the sound generation control unit 21 detects a person, the control unit 21 controls the cancellation signal generator 24 so that the degree by which the output level of the cancellation signal AC is lowered is changed in accordance with information on the distance from the vehicle to the detected person. That is, the sound generation control unit 21 performs the processes of the steps S108, S113, and S112. Thus, the degree to which the notification sound can be heard in the compartment is changed in accordance with the distance from the vehicle to the detected person outside the vehicle. Specifically, by performing these processes, the closer the person is to the vehicle, the higher the volume of the notification sound becomes in the compartment. Thus, the driver can be aware of the approach of the person and driver's recognition of the person can be enhanced, whereby safe driving can be promoted.

Furthermore, steps S107 and S108 branch to steps S114, S113, and S112 branch. This lowers the canceling effect and the driver can hear the notification sound clearly in accordance with the position of the detected person (in or out of the lane of the vehicle) and the distance from the vehicle to the person, as the risk of accidental contact between the vehicle and the person is increasing. This causes the driver to be more aware of the notification sound in accordance with the degree of danger, thereby promoting safer driving.

The sound generation control unit 21 in the vehicle approach notification apparatus 1 controls the cancellation signal generator 24 so that the cancellation signal AC is supplied to the compartment speaker 5 in the optimized state in effect of canceling the notification sound, during a period when a person is not detected by person detection and a traveling speed is detected to be in a low speed traveling state and equal to or lower than a given speed. This corresponds to the case where the processing advances to steps S101, S102, S103, S104, S105, S106, and S115 in sequence.

Thus, when there is no person in front of the vehicle and the vehicle is traveling at a low speed with an electric motor, in which the occupant is most likely to feel the notification sound as noise, a noise lowering effect in the compartment can be exerted and a comfortable environment can be provided to the occupant.

Also, the sound generation control unit 21 in the vehicle approach notification apparatus 1 monitors the operating state of the notification sound off-switch 7 operated by the occupant of the vehicle to turn off the notification sound. When the notification sound off-switch 7 is turned on, the output of the notification sound from the notification sound signal generator 22 is stopped (step S116). However, even during that period, if a person is detected, outputting of the notification sound from the notification sound signal generator 22 is automatically started (step S110). Furthermore, the sound generation control unit 21 controls the cancellation signal generator 24 so that the output level of the cancellation signal AC is lowered (steps S112, S113, and S114).

In the case where the notification sound is turned off in accordance with the intention of the occupant, when a pedestrian or the like exists near the vehicle and the notification sound off-switch 7 is kept off, it is not possible to notify the pedestrian or the like of the approaching vehicle by the notification sound. Thus, the vehicle approach sound is forcibly turned on in response to detection of a person, whereby it is possible to enhance safety. In addition, in this case, by making the notification sound audible in the compartment, the driver can be made aware of the notification sound and safer driving can be promoted.

In the configuration illustrated in FIG. 2, the cancellation signal AC is output as the canceling sound via the audio unit 6. Since this does not require an amplifier/speaker dedicated for outputting of the canceling sound, the configuration is simplified and the amount of mounting equipment on the vehicle is reduced. However, as a matter of course, the special amplifier/speaker for the output of the canceling sound may be provided.

The invention is not limited to the above implementation and various alterations may be adopted in the invention.

Processing illustrated in FIG. 4 may be altered for simplification so that step S115 or S112 is selected. That is, steps S107, S108, S113, and S114 may be omitted from FIG. 4. If there is no person, step S115 may optimize the noise canceling effect. If a person is detected, step S112 may cause the occupant to recognize the notification sound by lowering the noise canceling effect (or halting the noise canceling effect). This provides both a comfortable environment in the compartment and safety.

The invention may be embodied without the notification sound off-switch 7. In this case, steps S103, S109, and S110 are not necessary.

In the above implementation, the notification sound is output at a low vehicle speed. Alternatively, the notification sound may be output at all times during the electric motor traveling. In this case, step S102 is not necessary.

The transmission coefficient (an output level of the cancellation signal AC) of the notification sound may be minutely variably controlled in accordance with the vehicle speed and a shift position.

In the case where a reverse position is selected as the shift position move the vehicle backward, the sound quality of the notification sound or an output pattern may be changed. For example, the notification sound may be an intermittent sound. In this case, the canceling effect may be turned off.

The sound generation control unit 21 may variably control the canceling effect (the transmission coefficient of the notification sound) in accordance with another type of information. For example, the canceling effect of the notification sound may be changed in accordance with a time period. Specifically, for example, in the case where the occupant often feel the notification sound noise to be uncomfortable during the night, the canceling effect is enhanced at night time. Similarly, the canceling effect may be increased or decreased in accordance with illuminance of external light, weather conditions, the rotational speed of the motor, or the like. Furthermore, in the case where the audio unit 6 plays back the music or the like, the occupant can hardly hear notification sound noise. Thus, if the reproduced sound volume is high, the canceling effect of the notification sound may be applied only when the reproduced sound volume is low.

Examples of an object that is detected by the forward monitoring apparatus 10 and causes the sound generation control unit 21 to perform controlling include a pedestrian, a person on a bicycle, and an object expected to cause the notification sound. Animals other than human beings may also be included in the examples of the object to be detected.

1. A vehicle approach notification apparatus for a vehicle, comprising:
a notification sound signal generator that generates and outputs a notification sound signal that serves as a sound signal to be supplied to an external speaker that outputs a notification sound toward an outside of a vehicle; and
a cancellation signal generator that generates a cancellation signal that serves as a sound signal to be supplied to a compartment speaker to output a sound and that has an antiphase with respect to a phase of the notification sound signal output from the notification sound signal generator.

2. The vehicle approach notification apparatus for a vehicle according to claim 1, further comprising:
a control unit that controls the notification sound signal generator and the cancellation signal generator,
wherein the control unit controls the cancellation signal generator such that an output level of the cancellation signal is lowered in the case where a person is detected based on an information on person detection supplied from a forward monitoring apparatus.

3. The vehicle approach notification apparatus for a vehicle according to claim 2, wherein when a person is detected, the control unit controls the cancellation signal generator such that the output level of the cancellation signal is lowered in response to an information supplied from the forward monitoring apparatus, the information indicating a distance from the vehicle to the person.

4. The vehicle approach notification apparatus for a vehicle according to claim 2, wherein the control unit controls the cancellation signal generator such that the cancellation signal is supplied to the compartment speaker to achieve a state in which cancellation of the notification sound is optimized in a compartment under a condition that the control unit detects that the vehicle slowly travels with a motor at a speed equal to or lower than a given speed and no person is detected through the person detection.

5. The vehicle approach notification apparatus for a vehicle according to claim 3, wherein the control unit controls the cancellation signal generator such that the cancellation signal is supplied to the compartment speaker to achieve a state in which cancellation of the notification sound is optimized in a compartment under a condition that the control unit detects that the vehicle slowly travels with a motor at a speed equal to or lower than a given speed and no person is detected through the person detection.

6. The vehicle approach notification apparatus for a vehicle according to claim 2,
wherein the control unit receives from an operation unit information indicating that an occupant in the vehicle performs an operation to turn off the notification sound;
wherein the control unit stops outputting the notification sound signal from the notification sound signal generator under a condition that the control unit detects an information indicating that the operation is performed to turn off the notification sound; and
wherein the control unit starts outputting the notification sound signal from the notification sound signal generator and controls the cancellation signal generator to lower an output level of the cancellation signal in the case where a person is detected based on the information on the person detection supplied from the forward monitoring apparatus.

7. The vehicle approach notification apparatus for a vehicle according to claim 3,
wherein the control unit receives from an operation unit information indicating that an occupant in the vehicle performs an operation to turn off the notification sound;
wherein the control unit stops outputting the notification sound signal from the notification sound signal generator under a condition that the control unit detects an information indicating that the operation is performed to turn off the notification sound; and
wherein the control unit starts outputting the notification sound signal from the notification sound signal generator and controls the cancellation signal generator to lower an output level of the cancellation signal in the case where a person is detected based on the information on the person detection supplied from the forward monitoring apparatus.

8. The vehicle approach notification apparatus for a vehicle according to claim 4,
wherein the control unit receives from an operation unit information indicating that an occupant in the vehicle performs an operation to turn off the notification sound;
wherein the control unit stops outputting the notification sound signal from the notification sound signal generator under a condition that the control unit detects an information indicating that the operation is performed to turn off the notification sound; and
wherein the control unit starts outputting the notification sound signal from the notification sound signal generator and controls the cancellation signal generator to lower an output level of the cancellation signal in the case where a person is detected based on the information on the person detection supplied from the forward monitoring apparatus.

9. The vehicle approach notification apparatus for a vehicle according to claim 5,
wherein the control unit receives from an operation unit information indicating that an occupant in the vehicle performs an operation to turn off the notification sound;
wherein the control unit stops outputting the notification sound signal from the notification sound signal generator under a condition that the control unit detects an information indicating that the operation is performed to turn off the notification sound; and
wherein the control unit starts outputting the notification sound signal from the notification sound signal generator and controls the cancellation signal generator to lower an output level of the cancellation signal in the case where a person is detected based on the information on the person detection supplied from the forward monitoring apparatus.
